(19) United States
(12) Patent Application Publication
(10) Pub. No.: US 2011/0161015 A1
(43) Pub. Date: Jun. 30, 2011

(54) DETECTION MODULE

(75) Inventors: HAI LAN, Tu-Cheng (TW); GA-LANE CHEN, Santa Clara, CA (US); TAI-HSU CHOU, Tu-Cheng (TW)

(73) Assignee: HON HAI PRECISION INDUSTRY CO., LTD., Tu-Cheng (TW)

(21) Appl. No.: 12/822,240

(22) Filed: Jun. 24, 2010

(30) Foreign Application Priority Data
Dec. 29, 2009 (TW) 98145414

(51) Int. Cl. G01L 1/00; G06F 19/00

(52) U.S. Cl. 702/41

(57) ABSTRACT

A detection module includes MEMS force sensors, a processing unit, and a power supply unit. The MEMS force sensors are adapted to detect data values of forces that applied on corresponding measured points and output corresponding digital signals. The processing unit is adapted to receive and process the digital signals from the MEMS force sensors, and the power supply unit provides power to the processing unit.

### BACKGROUND

1. Technical Field

The present disclosure relates to detection modules, and particularly, to a detection module employing force sensors.

2. Description of the Related Art

Center-of-gravity measurement and motion detection are widely used in automation production lines, video games, and virtual-reality technologies, among other applications. Typically, a detection module using a Wheatstone bridge is used to measure an unknown electrical resistance by balancing two legs of a bridge circuit, one of which includes an unknown component. Generally, the unknown electrical resistance is detected by a resistance strain gauge adhered to a load carrying member on which a force is applied. However, the Wheatstone bridge outputs analog signals which must be amplified via an amplifier circuit and converted to digital signals via an A/D conversion circuit, before transmission to a processing unit or an actuator. In addition, the center-of-gravity measurement or motion detection modules utilizing the resistive strain gauges suffer from relatively low precision and slow response.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an embodiment of a detection module employing a plurality of MEMS force sensors to measure the center of gravity of a measured object.

FIG. 2 is a block diagram of an embodiment of a detection module employing a plurality of MEMS force sensors to detect motion of a moving object exerting force on a measured object.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

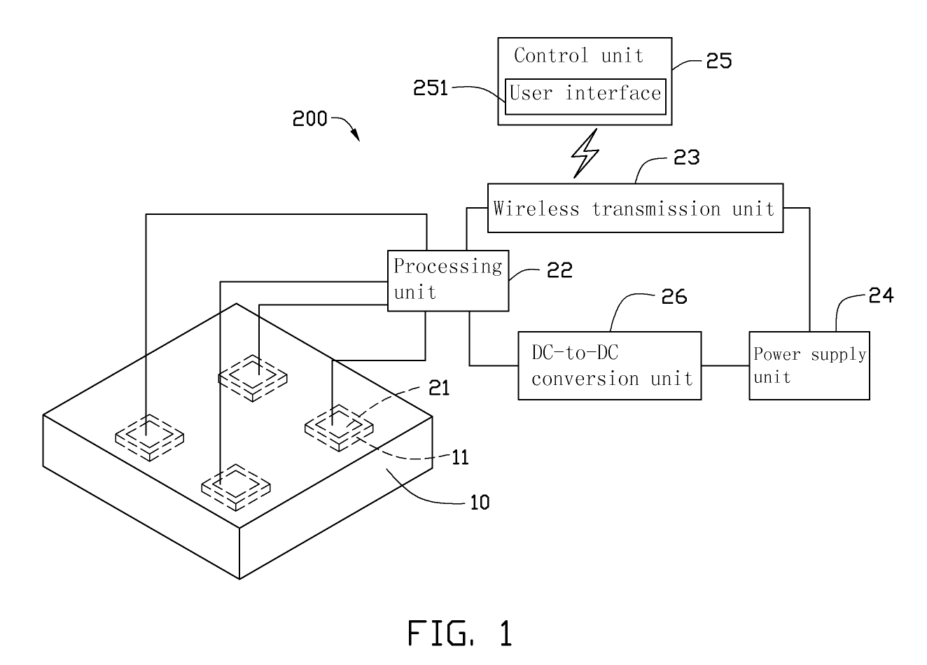

Referring to FIG. 1, an embodiment of a detection module 200 can be used to measure the center of gravity of a measured object 10. The detection module 200 includes a plurality of micro-electro-mechanical system (MEMS) force sensors 21, a processing unit 22, a wireless transmission unit 23, a power supply unit 24 and a control unit 25. The MEMS is the integration of mechanical elements, sensors, actuators, and electronics on a common silicon substrate through microfabrication.

In this embodiment, the detection module 200 is provided with four MEMS force sensors 21, each of which can be a piezoelectric sensor or a capacitance sensor. The four MEMS force sensors 21 are mounted on corresponding support members 11 which carry the weight of the measured object 10. The four MEMS force sensors 21 are arranged in a predetermined matrix, with distance between any two MEMS force sensors 21 predetermined. Each MEMS force sensor 21 is adapted to detect force applied on a corresponding measured point and output digital corresponding signals.

The processing unit 22 communicates with the MEMS force sensors 21 via data transmission channels and receives and processes the digital signals from the MEMS force sensors 21. When the measured object 10 is at rest, the sum of the force and moment applied thereon is equal to zero, the processing unit 22 calculates the center of gravity of the measured object 10 based upon the predetermined distance between any two of the four MEMS force sensors 21 and data values corresponding to the digital signals from the MEMS force sensors 21.

The wireless transmission unit 23 is electrically connected to the processing unit 22 and coupled to the control unit 25 via wireless communication interface. The control unit 25 includes a user interface 251 to show the data value for the force detected by the MEMS force sensors 21 on a screen, and/or generate instructions to the wireless transmission unit 23. In one embodiment, the wireless transmission unit 23 is a Bluetooth transmission unit. In other embodiments, the wireless transmission unit 23 can be omitted, and the control unit 25 directly coupled to the processing unit 22 to receive and process the signals from the processing unit 22.

The power supply unit 24 provides power to the processing unit 22 and wireless transmission unit 23. A DC-to-DC (direct current to direct current) conversion unit 26 connecting the power supply unit 24 and the processing unit 22 converts power from the power supply unit 24 to power suitable for the processing unit 22.

It should be understood that the number of the MEMS force sensors 21 utilized in the detection module 200 can be changed according to specific applications. The MEMS force sensors 21 can be selected to measure the forces applied on the measured points along one axis, two axes, or three axes. The processing unit 22 can be a micro control unit (MCU) or an application specific integrated circuit (ASIC).

Because the MEMS force sensors 21 can be mounted dependently without special mounting requirements and output digital signals, the detection module 200 can be easily mounted and achieve a higher precision.

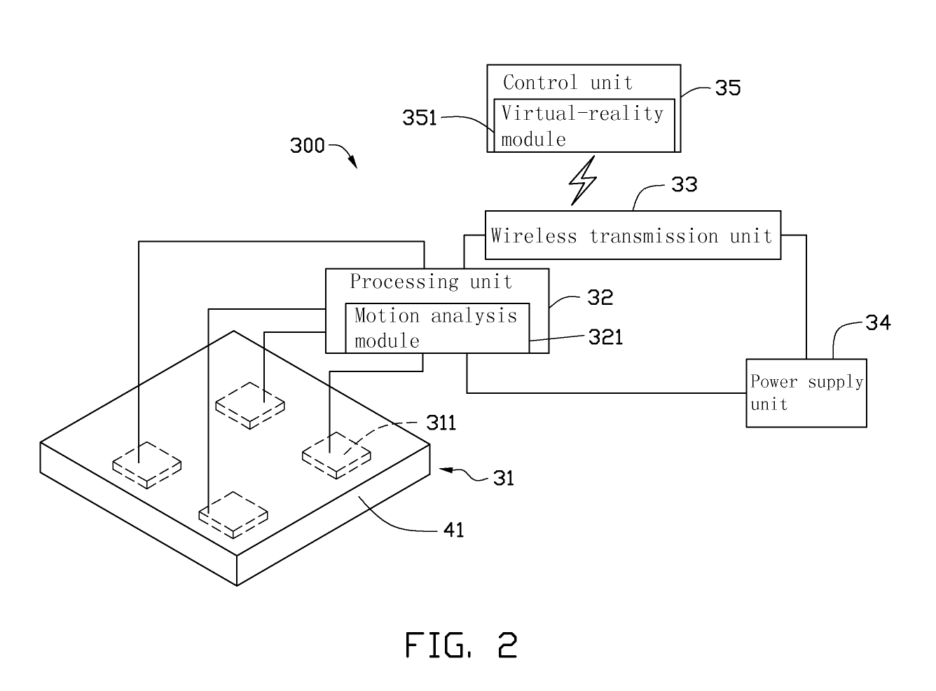

Referring to FIG. 2, an embodiment of a detection module 300 can be used to detect motion of a moving object (not shown) exerting force on a measured object 41. The detection module 300 includes a detecting unit 31, a processing unit 32 provided with a motion analysis module 321 therein, a wireless transmission unit 33, a power supply unit 34, and a control unit 35.

The detecting unit 31 includes a plurality of MEMS force sensors 311, each of which is adapted to measure the force the moving object applies on corresponding measured point of the measured object 41, and convert the data value of the force to digital signals, and output the digital signals to the processing unit 32.

The processing unit 32 is electrically connected to the detecting unit 31, to receive the digital signals from the detecting unit 31, and process the received digital signal to detect the motion of the moving object via the calculating of the motion analysis module 321.

The motion detection module 300 can be utilized in a dance arcade machine, and the measured object 41 is a detection board provided with four measured points each of which has a predetermined position. In one embodiment, the detecting unit 31 includes four MEMS force sensors 311 corresponding to the four measured points to detect contact on the measured point exerted by the moving object. User contact on the measured object 41 generates force on the measured points, detected by the MEMS force sensors 311, with corresponding force signals output to the processing unit 32 in real time and continuously.

The motion analysis module 321 of the processing unit 32 is programmable to evaluate contact with the measured object 41 based on force signals from the MEMS force sensors 311. For example, the analysis module 321 can determine whether a change in contact changes the data value for the detected forces. Because the MEMS force sensors 311 have high precision and fast response, the motion analysis module 321 is capable of receiving the force signals in real time and calculating motion in time, facilitating the processing unit 32 to generate instructions based on the result.

The wireless transmission unit 33 is coupled to the processing unit 32 to communicate with the processing unit 32. The power supply unit 34 supplies power for the processing unit 32 and the wireless transmission unit 33. The control unit 35 communicates with the wireless transmission unit 23 to receive the signals from the wireless transmission unit 33. In one embodiment, the control unit 35 includes a virtual-reality module 351 to display the user on a screen based on the digital signals from the wireless transmission unit 33.

It should be understood that the MEMS force sensors 311 can be selected to measure the forces applied on the measured points along one axis, two axes, or three axes. The processing unit 32 can be a MCU or an ASIC. In other embodiments, the wireless transmission unit 33 can be omitted, and the control unit 35 directly coupled to the processing unit 32.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

It is believed that the present embodiments and their advantages will be understood from the foregoing description, and it will be apparent that various changes may be made thereto without departing from the spirit and scope of the embodiments or sacrificing all of its material advantages, the examples hereinbefore descried merely being preferred or exemplary embodiments.

What is claimed is:

1. A detection module comprising:
a plurality of Micro-Electro-Mechanical System (MEMS) force sensors for detecting data values of forces applied on corresponding measured points and outputting corresponding digital signals;
a processing unit for receiving and processing the digital signals from the plurality of MEMS force sensors; and
a power supply unit for supplying power to the processing unit.

2. The detection module of claim 1, wherein a predetermined distance is defined between any two of the plurality of MEMS force sensors, and the processing unit is adapted to calculate the center of gravity of an object based on the digital signals from the plurality of MEMS force sensors and the predetermined distance between two MEMS force sensors.

3. The detection module of claim 2, further comprising a wireless transmission unit coupled to the processing unit, and a control unit in communication with the wireless transmission unit.

4. The detection module of claim 3, wherein the wireless transmission unit is a Bluetooth transmission unit.

5. The detection module of claim 3, wherein the control unit comprises a user interface capable of showing the data value detected by the plurality of MEMS force sensors on a screen and generating instructions to the wireless transmission unit.

6. The detection module of claim 2, wherein the number of the plurality of MEMS force sensors is four, and the four MEMS force sensors are arranged in a matrix.

7. The detection module of claim 1, wherein the processing unit is adapted to receive and process the digital signals from the plurality of MEMS force sensors and comprises a motion analysis module adapted to calculate motion of a moving object exerting force on the measured object based upon the digital signals from the plurality of MEMS force sensors.

8. The detection module of claim 7, wherein each of the plurality of MEMS force sensors is capable of outputting the digital signals in real time and continuously.

9. The detection module of claim 7, further comprising a wireless transmission unit coupled to the processing unit and a control unit in communication with the wireless transmission unit.

10. The detection module of claim 9, wherein the wireless transmission unit is a Bluetooth transmission unit.

11. The detection module of claim 9, wherein the control unit comprises a virtual-reality module to display the motion of the moving object on a screen based upon signals from the wireless transmission unit.

12. The detection module of claim 1, wherein the processing unit is a micro control unit.

13. The detection module of claim 1, wherein the processing unit is an application specific integrated circuit.

14. The detection module of claim 1, wherein each of the plurality of MEMS force sensors measures the force applied on the measured points along one axis, two axes, or three axes.

15. A detection module comprising:
a plurality of Micro-Electro-Mechanical System (MEMS) force sensors capable of detecting data values of forces applied on corresponding measured points and outputting corresponding digital signals;
a processing unit in communication with the plurality of MEMS force sensors capable of receiving and processing the digital signals; and
a power supply unit capable of supplying power to the processing unit.

16. The detection module of claim 15, wherein a predetermined distance is defined between any two of the plurality of MEMS force sensors, and the processing unit is adapted to calculate the center of gravity of an object based on the digital signals and the predetermined distance.

17. The detection module of claim 15, wherein the processing unit is adapted to receive and process the digital signals and comprises a motion analysis module adapted to calculate motion of a moving object exerting force on the measured object based upon the digital signals from the plurality of MEMS force sensors.

18. The detection module of claim 17, wherein each of the plurality of MEMS force sensors is capable of outputting the digital signals in real time and continuously.

19. The detection module of claim 15, wherein the processing unit is a micro control unit or an application specific integrated circuit.

20. The detection module of claim 15, wherein each of the plurality of MEMS force sensors measures the force applied on the measured points along one axis, two axes, or three axes.
